(19) United States
(12) Patent Application Publication
(10) Pub. No.: US 2004/0096320 A1
(43) Pub. Date: May 20, 2004

(54) Multistage submersible axial-flow pump

(76) Inventors: Anatoliy A. Yevtushenko, Sumy (UA); Oleksandr V. Yelin, Sumy (UA); Nikolay N. Lilak, Okhtyrka (UA); Igor B. Tverdokhleb, Sumy (UA)

Correspondence Address: Svetlana Ivarova, 5215 Hoffman Drive, Schnecksville, PA, 18078, US

(21) Appl. No.: 10/607,686

(22) Filed: Jun. 26, 2003

(30) Foreign Application Priority Data
Jun. 27, 2002 (UA) 2002065305

(51) Int. Cl. F03D 1/04

(52) U.S. Cl. 415/199.5

(57) ABSTRACT

The multistage submersible axial-flow pump may be successfully used, in particular, in systems of water intake, in oil and gas producing branches of industry, in mining, etc., with the purpose to lift stratal liquids and gas-liquid mixtures with increased gas content from boreholes.

This pump contains axial stages arranged sequentially on the shaft inside casing. Each of these stages contains an impeller and stator guide vanes. The blades are arranged at lateral surface of the impeller hub, along the helical line. The inlet edges of blades are rounded, the inclination angle of blades relative to the face surfaces of the hub obey the law

$${β}_{b l} ( {r}_{i} ) = arctg ( \frac{S}{2 \times π \times {r}_{i}} ) ,$$

where β_{bl} (rᵢ)—inclination angle of blades at the radius rᵢ;

S—lead of helix;

rᵢ—radius measured from the impeller axis till the current point at the blade surface.

Guide vanes consist of a hub with radial vanes inserted at its lateral surface.

Advantages of the Pump of Suggested Design

Increase of manufacturability and decrease of labor consumption.

Opportunity to automatize the production process.

Increase of head and efficiency.

Increase of reliability and durability due to ensuring stable operation when pumping gas-liquid mixtures with increased gas content.

Opportunity of wide application in oil and gas producing branches of industry, in mining, with high performance characteristics.

### BRIEF SUMMARY OF THE INVENTION

The invention refers to the pump building industry and may be used in systems of water intake, in oil and gas producing branches of industry, in mining, etc., with the purpose to lift stratal liquids and gas-liquid mixtures with increased gas content from boreholes.

### BACKGROUND OF THE INVENTION

It is known a multistage submersible pump that contains eight axial stages arranged sequentially on the shaft inside casing. Each of these stages contains an impeller with profiled blades and profiled guide vanes (see Lomakin A. A. “Centrifugal and Axial-Flow Pumps” (in Russian), Moscow—Leningrad, Ed. by “Mashinostroenie”, 1966, p. 348, FIG. 235).

In that pump the impeller blades and guide vanes are composed of complex profiles of aerodynamic shape. Their production requires complex and expensive manufacturing process. Besides, if radial dimensions are small, a pump of such design has low efficiency. In addition, that design does not ensure high reliability when pumping gas-liquid mixtures with increased gas content.

One should notice that complex aerodynamic profiles of impeller blades and guide vanes in that design, in general, does not allow for creation of pump that would ensure reliable and efficient operation, including pumping of gas-liquid mixtures with increased gas content.

### DETAILED DESCRIPTION OF THE INVENTION

The main purpose of this invention is creation of multistage submersible axial-flow pump, which design would ensure reliable and efficient operation, including pumping of gas-liquid mixtures with increased gas content.

This problem is solved applying to the following design of pump. The pump contains axial stages arranged sequentially on the shaft inside casing. Each of these stages contains guide vanes and impellers. Each impeller consists of a hub, two end washers and several blades. The diameter of the impeller hub d_{hub} at the impeller inlet equals to

$${d}_{hub} = {D}_{extimp} \times \sqrt{1 - {[ \frac{{K}_{D}}{{D}_{extimp}} \times {( \frac{Q}{60 n} )}^{1 / 3} ]}^{2} ,}$$

where D_{ext imp}—external diameter of impeller, m;

K_{D}=3.2÷4.5—factor of impeller diameter;

Q—capacity of pump;

n—rotational speed.

The end washers are fixed at the face surfaces of the hub and are made of antifriction wearproof material. The blades are arranged at lateral surface of the hub along the helical line with the lead of helix of

$$S = \frac{π \times {D}_{extimp} \times ( 1 + {\overline{d}}_{hub} )}{2} \times tg [ 2 \times arctg ( \frac{480 \times Q}{{π}^{2} \times {D}_{extimp}^{3} \times n \times [ 1 + {\overline{d}}_{hub} ] \times [ 1 - {\overline{d}}_{hub}^{2} ]} ) ] ,$$

where

$${\overline{d}}_{hub} = \frac{{d}_{hub}}{{D}_{extimp}}$$

—hub ratio at the impeller inlet.

The inlet edges of blades are rounded, the inclination angle of blades relative to the face surfaces of the hub obey the law

$${β}_{b l} ( {r}_{i} ) = arctg ( \frac{S}{2 \times π \times {r}_{i}} ) ,$$

where β_{bl} (rᵢ)—inclination angle of blades at the radius rᵢ;

S—lead of helix;

rᵢ—radius measured from the impeller axis till the current point at the blade surface.

Density τ_{ext imp} of blade lattice at the external diameter has the value of

$${τ}_{extimp} = \frac{{l}_{extimp} \times {z}_{imp}}{π \times {D}_{extimp}} = 0.7 \div 1.3 ,$$

where l_{ext imp}—blade length at the external diameter;

zᵢₘₚ—number of blades.

Each stator guide vanes consist of a hub with two end shoulders and several vanes. The radial vanes are installed at lateral surface of the hub along the direction parallel to stage axis. Both inlet and outlet edges of vanes are rounded. Density τ_{av gv} of circular vane lattice at the middle diameter D_{av gv} has the value of

$${τ}_{avgv} = \frac{{l}_{gv} \times {z}_{gv}}{π \times {D}_{avgv}} = 0.8 \div 1.6 ,$$

where l_{ext imp}—vane length;

zᵢₘₚ—number of vanes.

Design of impeller as a hub with blades arranged at its lateral surface along the helical line inclined relative to its face surfaces, due to its simplicity, permits to automate the production of blades as very labor-consuming and numerous parts of impellers. Hydrodynamic characteristics of helical blades permits, under small radial dimensions, to attain high efficiency of pump that equals, in dependence on operation parameters, 70-80%.

Impellers of this design are of high reactivity factor (up to 0.85), and this permits to simplify design of guide vanes, by simplifying guiding of flow.

Use of straight radial stator vanes allows for performing axial inflow of working fluid upon the impeller of the next stage.

Inlet edges of impeller blades and guide vanes are made round shaped, and this allows for obtaining high performance of pump, due to reducing vortex losses at the suction side of blades and vanes that are inevitable at the shock inflow. Outlet edges of stator guide vanes are made round shaped too, and this allows for obtaining almost uniform velocity pattern of fluid flow at the outlet of guide vanes and at the inlet of the impeller of the next stage, provided the density of vane lattice is high enough.

The end washers, made of antifriction wearproof material, are fixed at the face surfaces of the impeller hub, and the end shoulders are provided at the face surfaces of the hub of guide vanes. Thus, impellers are discharged from axial thrust without additional hydraulic losses and with minimal losses of power due to mechanical friction. These losses do not exceed 5-8% of total power.

The above recommended hub ration of impeller allows for obtaining the maximum possible efficiency of the pump.

The recommended lead of helix ensures that the maximum efficiency is attained at the calculated capacity.

By varying the length of the hub of impeller (or guide vanes) and the number of impeller blades (or guide vanes), while keeping the density of blade (or vane) lattice inside the indicated range, it is possible to change the axial dimension of a stage. Thus, it is also possible to change the total head of the pump, provided the length of the pump is constant.

Thus, a multistage submersible axial-flow pump, fulfilled according to this invention, is of high manufacturability and ensures reliable and efficient operation in oil and gas producing branches of industry and mining, including pumping of gas-liquid mixtures with increased gas content.

Below is the description of a particular example of a pump designed according to this invention, with references to supplied drawings.

### BRIEF DESCRIPTION OF THE SEVERAL VIEWS OF THE DRAWING

FIG. 1. Schematic assembly of the proposed multistage submersible axial-flow pump.

FIG. 2. Perspective view of an impeller and guide vanes.

### DESCRIPTION OF THE PREFERRED EMBODIMENT

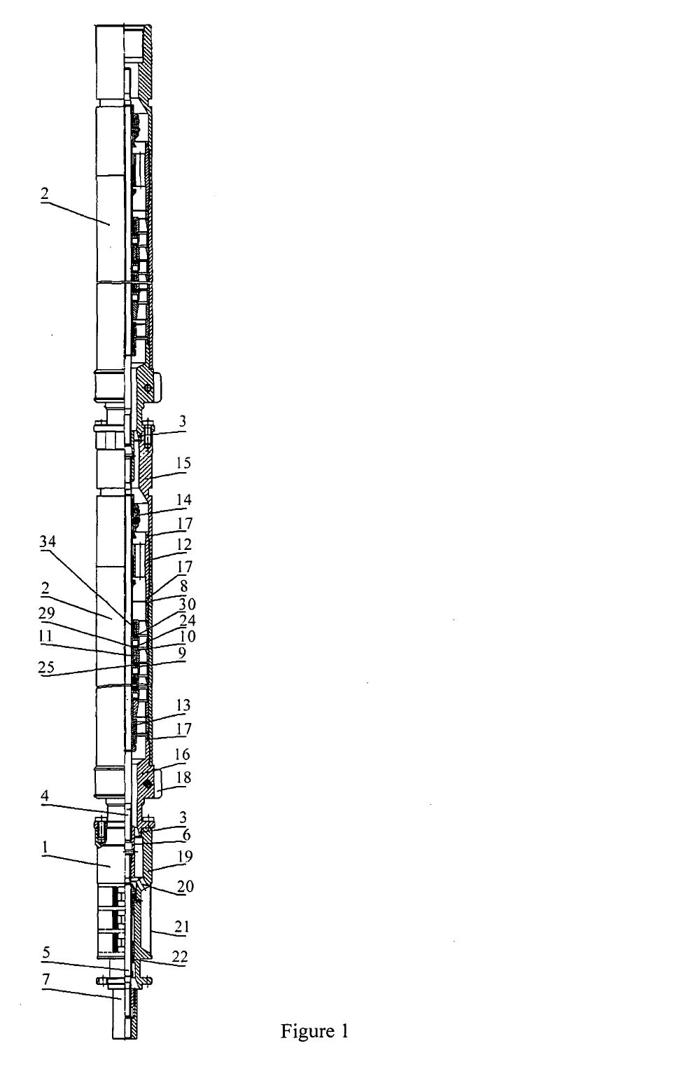

A multistage submersible axial-flow pump designed according to this invention contains (FIG. 1) the entrance unit 1 and one to five stage units 2, depending on the required pump head.

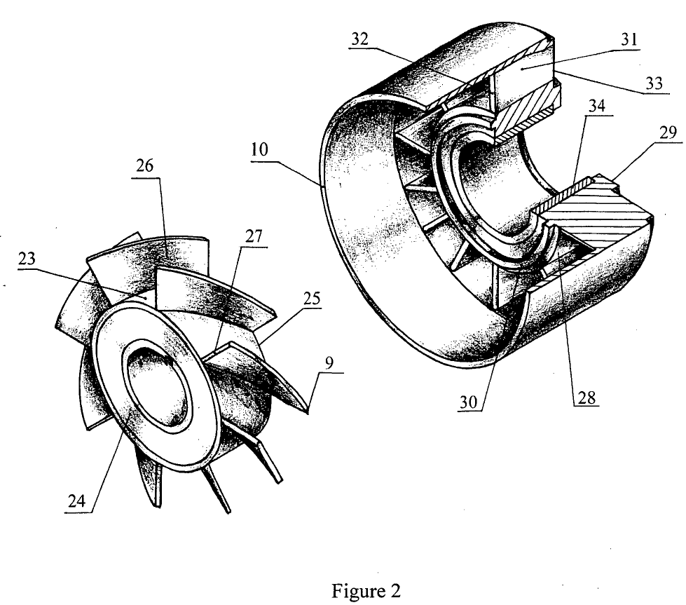

Stages 2 are interconnected via flanges, the inlet unit 1 of the pump is connected to the engine via a flange too. The interstage joints are sealed with rubber rings 3. Shafts 4 of stage units 2 are interconnected via spline couplings 6, the shaft 5 of inlet unit 1 is connected to the engine shaft via a spline coupling 7. Stage units 2 contain the following parts: casing 8, impeller 9 (FIGS. 1, 2), guide vanes 10 (FIGS. 1, 2), interstage hub 11, lower and upper bearings 12 and 13, upper thrust bearing 14, head 15 and base 16. The upper bearing 12 is connected to the head 15 and casing 8, as well as the base 16 to the casing 8, via threads sealed with rubber rings 17. At each base of stage units 2 there are two steel ribs 18, in order to protect the flat power cable of the electric engine from being mechanically damaged when sinking or lifting the submersible pump. Casing 19 of the inlet unit 1, being the inlet unit of the pump, is equipped with suction holes 20 and net (filter) 21 for entering the medium pumped. The shaft of the inlet casing runs in own radial bearings 22. An impeller 9 (FIG. 2) consists of a hub 23 with two end washers 24, 25 fixed at its face surfaces. The blades 26 are arranged at lateral surface of the hub 23 along the helical line with the constant lead of helix. Their inlet edges 27 are rounded with the radius equal to half of the blade thickness. Stator guide vanes 10 (FIG. 2) consist of a hub 28 with two shoulders 29, 30 provided at their face surfaces. The radial vanes 31 are arranged at lateral surface of the hub. Their inlet edges 32 and outlet edges 33 are rounded with the radius equal to half of the vane thickness too.

The pump operates as follows. The head of medium pumped is increased, as it passes between blades 26 of impellers, due to shock inflow upon their inlet edges 27. After passing an impeller 9, the medium pumped loses its swirl between stator guide vanes 10 and enters an impeller of the next stage as axial flow.

The axial thrust acts upon impellers at stable operation modes and is borne by the lower individual thrust bearing. This bearing consists of washer 24 and shoulder 29. During starts and stops, as well as during operation at capacities above optimum, axial load upon impellers can decrease till zero, and than change to the opposite direction. At this time, impellers are floated and supported by the upper individual thrust bearing. That bearing consists of washer 25 and shoulder 30. Residual axial thrust upon the rotors of stage units is borne by the upper axial bearing 14 provided in each of them. The radial forces that act upon the rotor are borne by upper 12 and lower 13 bearings at the ends of shafts of stage units, as well as radial bearings 34 installed in each stator guide vanes.

We claim:

1. A multistage submersible axial-flow pump with axial stages arranged sequentially on the shaft inside casing, each of these stages contains guide vanes and a hub-shaped impeller, and the diameter of the impeller hub d_{hub} at the impeller inlet equals to
$${d}_{hub} = {D}_{extimp} \times \sqrt{1 - {[ \frac{{K}_{D}}{{D}_{extimp}} \times {( \frac{Q}{60 n} )}^{1 / 3} ]}^{2} ,}$$
where Dₑₓₜᵢₘₚ—external diameter of impeller, m;
K_{D}=3.2÷4.5—factor of impeller diameter;
Q—capacity of pump, m³/s;
n—rotational speed.

2. The pump of claim 1, wherein the end washers are fixed at the face surfaces of the hub and are made of antifriction wearproof material, the blades are arranged at the lateral surface of the hub along the helical line with the lead of helix of
$$S = \frac{π \times {D}_{extimp} \times ( 1 + {\overline{d}}_{hub} )}{2} \times tg [ 2 \times acrtg ( \frac{480 \times Q}{{π}^{2} \times {D}_{extimp}^{3} \times n \times [ 1 + {\overline{d}}_{hub} ] \times [ 1 - {\overline{d}}_{hub}^{2} ]} ) ] ,$$
where
$${\overline{d}}_{hub} = \frac{{d}_{hub}}{{D}_{extimp}}$$
—hub ratio at the impeller inlet.

3. The pump of claim 1, wherein the inlet edges of the blades are rounded and the inclination angle of the blades relative to the face surfaces of the hub obey the law
$${β}_{bl} ( {r}_{i} ) = arc tg ( \frac{S}{2 \times π \times {r}_{i}} ) ,$$
where β_{bl} (rᵢ)—inclination angle of blades at the radius rᵢ;
S—lead of helix;
rᵢ—radius measured from the impeller axis till the current point at the blade surface.

4. The pump of claim 1, where the density of the blade lattice at the external diameter has the value of
$${τ}_{extimp} = \frac{{l}_{extimp} \times {z}_{imp}}{π \times {D}_{extimp}} = 0.7 \div 1.3$$
Where τₑₓₜᵢₘₚ—density of the blade lattice
lₑₓₜᵢₘₚ—blade length at the external diameter
zᵢₘₚ—number of blades

5. The pump of claim 1, where each stator guide vanes contain a hub with two end shoulders at their face surfaces, the radial vanes are installed at lateral surface of the hub along the direction parallel to the stage axis, and both inlet and outlet edges of vanes are rounded. Density of circular vane lattice at the middle diameter has the value of
$${τ}_{av gv} = \frac{{l}_{gv} \times {z}_{gv}}{π \times {D}_{av gv}} = 0.8 \div 1.6 ,$$
where τ_{av gv}—density of the circular vane lattice;
l_{gv}—vane length
z_{gv}—number of vanes
